(19) United States
(12) Patent Application Publication
(10) Pub. No.: US 2012/0188352 A1
(43) Pub. Date: Jul. 26, 2012

(54) CONCEPT OF SUPERIMPOSING AN INTRAOPERATIVE LIVE IMAGE OF AN OPERATING FIELD WITH A PREOPERATIVE IMAGE OF THE OPERATING FIELD

(75) Inventors: Thomas WITTENBERG, Erlangen (DE); Sven FRIEDL, Nuernberg (DE)

(73) Assignee: Fraunhofer-Gesellschaft zur Foerderung der angewandten Forschung e.V., Munich (DE)

(21) Appl. No.: 13/412,976

(22) Filed: Mar. 6, 2012

Related U.S. Application Data
(63) Continuation of application No. PCT/EP2010/063000, filed on Sep. 4, 2010.

(30) Foreign Application Priority Data
Sep. 7, 2009 (DE) 102009040430.9

(51) Int. Cl. H04N 5/262; H04N 7/18

(52) U.S. Cl. 348/65; 348/239; 348/E05.051; 348/E07.085

(57) ABSTRACT

A device for superimposing an intraoperative first live image of an operating field with a preoperative second image of the operating field includes a capturer/provider for capturing and providing the first image, a provider for providing the second image, a definer for defining characteristic points in the first image and for defining points, which correspond to the characteristic points, in the second image, so that the characteristic points and the points corresponding thereto in the first and second images will mark mutually corresponding positions of the operating field, a transformer for transforming the image(s), so that the characteristic points of the first image and the points, which correspond thereto, of the second image will come to lie one above the other, and a superimposer for superimposing, following transformation, the second image with the first image or with the operating field to obtain a superimposed view of the operating field.

### CROSS-REFERENCE TO RELATED APPLICATIONS

This application is a continuation of copending International Application No. PCT/EP2010/063000, filed Sep. 4, 2010, which is incorporated herein by reference in its entirety, and additionally claims priority from German Application No. 102009040430.9-35, filed Sep. 7, 2009, which is also incorporated herein by reference in its entirety.

### BACKGROUND OF THE INVENTION

The present invention relates to a concept of superimposing an intraoperative live image of an operating field (a surgical area) with a preoperative image of the operating field as may be employed, for example, to support intraoperative navigation in surgery.

Coronary artery bypass grafting (CABG) includes, in industrial nations, common operative interventions within the context of heart surgery which involve bridging constricted or completely closed coronary vessels so as to restore sufficient blood supply of the heart muscle. As with most interventions, preoperative planning is important and is performed as a matter of routine. Various imaging processes are employed to prepare such an intervention and to support a surgeon in localizing the operating field of interest to him/her.

From the point of view of a surgeon, an angiography (coronary angiography), when properly performed, represents a suitable diagnostic procedure in coronary bypass operations. Angiography is understood to mean representation of blood vessels by means of so-called imaging processes, for example X-ray examination or magnetic resonance tomography (MRT). In this context, a contrast medium, i.e. a substance which enhances an image contrast and is particularly well visible in a selected examination method, is injected into a blood vessel. The interior of the vessel, which is filled with the contrast medium, will then show on the image, or angiogram, of the body region captured. Currently, non-invasive tests cannot yet represent the extent or the spreading of an anatomical heart disease with sufficient accuracy. Cardiac computer tomography (CT) is an up-and-coming and growing field, but has not been widespread so far. In bypass operations, angiographic images, i.e. angiograms, are typically used for detecting stenoses, i.e. constriction of blood vessels or other hollow organs, and potential positions of anastomoses, i.e. connections between two anatomical structures such as blood vessels, for example.

In addition to effective planning of the intervention, there has been a lack of a link between a high level of availability of preoperative tools, such as preoperative image data, and planning data at the point of care, or operating field, such as live images of the operating field, for example. A live image refers to an image that is recorded and transmitted directly, or in real time. Thus, a live image captured by using a camera or an endoscope is immediately forwarded to a display device (e.g. a monitor).

Preoperatively obtained angiographic image data is used for planning an intervention. Even though said image data is accessible at the operating table, it is accessible only in the form of external monitors or printouts. However, a physician is expected to transfer regions of interest from the preoperative image to a current view of the operating field. The fact that a cardiologist is responsible for a cardiac catheter and for interpreting the planning data, whereas a heart surgeon places the actual bypass, reveals that complications may arise. Even though this approach is ideal in many cases and current practice is sufficient, more complex and more difficult scenarios exist (in particular in minimally invasive surgery, MIS) where this may be a real challenge, in particular for young and inexperienced surgeons. The view of the operating field is limited, and the preoperative image data is mostly obtained by using other position and shape parameters than the live images. Coronary vessels are visible in most angiograms, whereas during an operation, they are hidden beneath a layer of fat on the surface of the heart. In the growing field of minimally invasive surgery, visibility of anatomical structures is clearly restricted, which is why keeping one's bearings, e.g. on the surface of the heart, represents a challenge.

Navigation systems for intraoperative assistance to physicians have become established on the market. They are essentially based on clearly recognizable markers or electromagnetic processes for position finding. This involves attaching markers in the form of metallic or similar objects to a patient and/or to surgical instruments, which objects may be identified and tracked even during the intervention by optical tracking systems in the preoperative image, which has been obtained by means of radiological processes in most cases. A different approach is utilization of an electromagnetic field to determine a current position of the surgical instruments by means of induction. An superimposed view of the preoperative image data is enabled, in this context, by adapting same by means of the positional data of the surgical instruments which has thus been obtained.

All of the previous approaches have in common that they are based on utilizing additional (electro)mechanical tools. This results in an interference with the patient, which in various situations is not possible or undesirable. In particular, attaching markers to a patient may have medical or diagnostic side effects.

### SUMMARY

According to an embodiment, a device for superimposing an intraoperative first live image of an operating field with a preoperative second image of the operating field may have: a capturer/provider for capturing and providing the first image; a provider for providing the second image; a definer for defining characteristic points in the first image and for defining points, which correspond to the characteristic points, in the second image, so that the characteristic points and the points corresponding thereto in the first and second images will mark mutually corresponding positions of the operating field, wherein the definer for defining the characteristic points and the points corresponding thereto includes an electronic input device so as to mark the characteristic points in the first image and the corresponding points in the second image, respectively; a transformer for transforming the first and/or second image(s), so that the characteristic points of the first image and the points, which correspond thereto, of the second image will come to lie one above the other; and a superimposer for superimposing, following transformation, the second image with the first image or with the operating field so as to acquire a superimposed view of the operating field, wherein the provider for providing the first image is configured to provide several frames of the operating field in a temporally successive manner, a tracker being provided for tracking the positions of the defined characteristic points in the temporally successive images, and the transformer being configured to perform, on the basis thereof, a transformation for each of the several frames.

According to another embodiment, a method of superimposing an intraoperative first live image of an operating field with a preoperative second image of the operating field may have the steps of: capturing and providing the first image; providing the second image; defining characteristic points in the first image and for defining points, which correspond to the characteristic points, in the second image, so that the characteristic points and the points corresponding thereto in the first and second images will mark mutually corresponding positions of the operating field, wherein said defining of the characteristic points and of the points corresponding thereto includes an electronic input device so as to mark the characteristic points in the first image and the corresponding points in the second image, respectively; transforming the first and/or second image(s), so that the characteristic points of the first image and the points, which correspond thereto, of the second image will come to lie one above the other; and following transformation, superimposing the second image with the first image or with the operating field so as to acquire a superimposed view of the operating field, wherein said providing of the first image includes providing several frames of the operating field in a temporally successive manner, a tracker being provided for tracking the positions of the defined characteristic points in the temporally successive images, and the transformer being configured to perform, on the basis thereof, a transformation for each of the several frames.

Another embodiment may have a computer program for performing the method of superimposing an intraoperative first live image of an operating field with a preoperative second image of the operating field, which method may have the steps of: capturing and providing the first image; providing the second image; defining characteristic points in the first image and for defining points, which correspond to the characteristic points, in the second image, so that the characteristic points and the points corresponding thereto in the first and second images will mark mutually corresponding positions of the operating field, wherein said defining of the characteristic points and of the points corresponding thereto includes an electronic input device so as to mark the characteristic points in the first image and the corresponding points in the second image, respectively; transforming the first and/or second image(s), so that the characteristic points of the first image and the points, which correspond thereto, of the second image will come to lie one above the other; and following transformation, superimposing the second image with the first image or with the operating field so as to acquire a superimposed view of the operating field, wherein said providing of the first image includes providing several frames of the operating field in a temporally successive manner, a tracker being provided for tracking the positions of the defined characteristic points in the temporally successive images, and the transformer being configured to perform, on the basis thereof, a transformation for each of the several frames, when the computer program runs on a computer or microcontroller.

The core idea of the present invention is to optimally match an intraoperative live image of an operating field, i.e. an image obtained during a surgical intervention, with an image of the operating field, e.g. the heart, that has been preoperatively obtained. Both images to be registered, i.e. an intraoperative live image and a preoperative image, typically differ from each other because they were taken from different positions (i.e. from different perspectives), at different points in time and/or by using different sensors. In accordance with an embodiment, the intraoperative live image is specified as being the reference image. By interactively placing characteristic points or landmarks, a surgeon may mark specific image points or image areas of the operating field in the live image. In addition, the surgeon may define, in the preoperative image, points which correspond to the characteristic points of the live image so as to specify corresponding points and/or areas of the operating field in the preoperative image. By means of the characteristic points in the live image and of the points in the preoperative image which correspond thereto, a transformation is then performed which adapts the preoperative image to the live image in the best possible manner. Following the transformation, the regions of interest of the live image and the associated, or corresponding, regions of the image obtained preoperatively will lie one above the other, respectively. By means of superimposed visualization, the surgeon may be provided with an expanded view—corresponding to a virtual reality, as it were—in the form of an image of the operating field which is a combination of a live image and a preoperative image.

To solve the above object, embodiments of the present invention provide an apparatus for superimposing an intraoperative first live image of an operating field with a preoperative second image of the operating field. An inventive device includes a means for capturing and providing the intraoperative live image of the operating field and a means for providing the preoperative image of the operating field. In addition, a means is provided for defining characteristic points in the intraoperative first live image, or a first image derived therefrom, and for defining points in the preoperative image which correspond to the characteristic points, so that the characteristic and the corresponding points in the first and second images mark mutually corresponding image points. A means for transforming transforms the first and/or the second image(s), so that the characteristic points of the first image and the corresponding points of the second image will come to lie one above the other, at least approximately, following the transformation. The device also includes a means for visualizing the second preoperative image superimposed with the first image or the operating field.

As has already been described above, superimposed visualization of both images may provide a surgeon with an “expanded” view of the operating field. This is effected, in accordance with an embodiment, either by superposing image data of the first and second images following transformation on a display device, such as a monitor for example, or, in accordance with another embodiment, immediately by projecting the transformed preoperative image onto the operating field, or the situs.

Since during operation, the view of the situs, or the situs itself, does not remain constant and is often physiologically moved, the marked characteristic points (landmarks) may be tracked, in accordance with embodiments, by means of a suitable method in temporally successive live images. To this end, methods of movement tracking, in particular of point tracking, may be employed, so that the movements and, thus, also the characteristic points, or landmarks, may be tracked over time. Image registration and/or transformation, and the superposition resulting therefrom are adapted, for each new live image, in accordance with the new positions of the characteristic points, or the new landmarks.

In complex situations, the inventive concept enables expanding the view of an operating field by superimposing and projecting pictures that have been adaptively adjusted and obtained preoperatively onto an intraoperative live image without using tools additionally attached to the patient or to the surgical instruments. That is, additional technical tools interfering with a patient are dispensed with. By tracking the positions of the marked characteristic points, or landmarks, useful visualization may also be guaranteed for moving organs.

In accordance with an embodiment, an inventive device may thus be used for expanded visualization in intraoperative navigation by means of interactive registration of preoperative image data and intraoperative live images.

### BRIEF DESCRIPTION OF THE DRAWINGS

Embodiments of the present invention will be detailed subsequently referring to the appended drawings, in which:

FIG. 1 shows a schematic representation of a device for superimposing a first image with a second image in accordance with an embodiment of the present invention;

FIG. 2 shows an operating scene during heart surgery;

FIG. 3 shows interactively marked characteristic points in an intraoperative live image and points in a preoperative image which correspond thereto;

FIG. 4 shows a combined image of a first image and a transformed second image superimposed over each other;

FIG. 5 shows a representation of tracking characteristic points in successive frames of an intraoperative live image up to a restriction of the view of the operating field by the intervention;

FIG. 6 shows a schematic representation of an approach in accordance with an embodiment of the present invention; and

FIG. 7 shows a flowchart of a method of superimposing an intraoperative live image with a preoperative image of the operating field in accordance with an embodiment of the present invention.

### DETAILED DESCRIPTION OF THE INVENTION

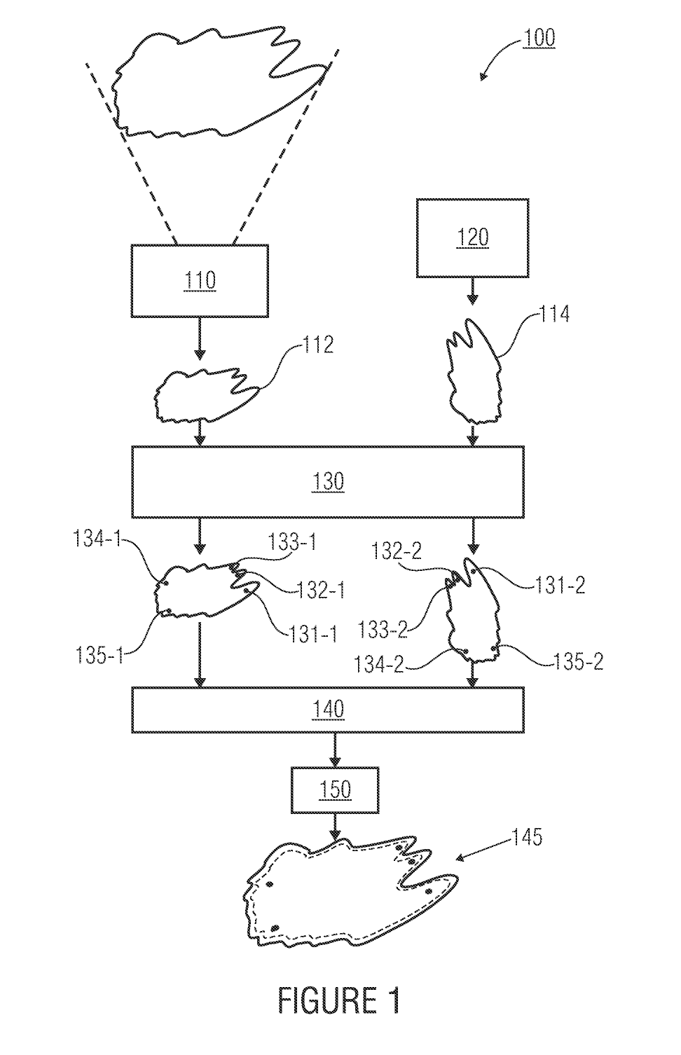

FIG. 1 schematically shows a device 100 for superimposing an intraoperative first live image 112 of an operating field 105 with a preoperative second image 114 of the operating field.

The device 100 includes a means 110 for capturing and providing the first image 112, i.e. the intraoperative live image, and a means 120 for providing the second image 114, i.e. the image obtained preoperatively. A means 130 for defining characteristic points 131-1, 132-1, 133-1, 134-1 and 135-1 in the first image 112 and for defining points 131-2, 132-2, 133-2, 134-2 and 135-2 which correspond to the characteristic points 131-1 to 135-1 is also provided. The first image 112 and the second image 114 typically show the operating field 105 from different perspectives. The characteristic points 131-1 to 135-1 and the points 131-2 to 135-2 corresponding thereto mark mutually corresponding image points and/or positions in the intraoperative live image 112 and the preoperative image 114 of the operating field. The device 100 further includes a means 140 for transforming the first and/or second images 112, 114, so that the characteristic points 131-1 to 135-1 of the first image 112 and the points 131-2 to 135-2 of the second image 114 which correspond thereto will at least approximately come to lie one above the other following the transformation. Following the transformation, a means 150 visualizes the second image 114 superimposed with the first image 112 or the operating field 105, so that by means of the superimposed visualization, an expanded and/or combined view 145 of the operating field is provided.

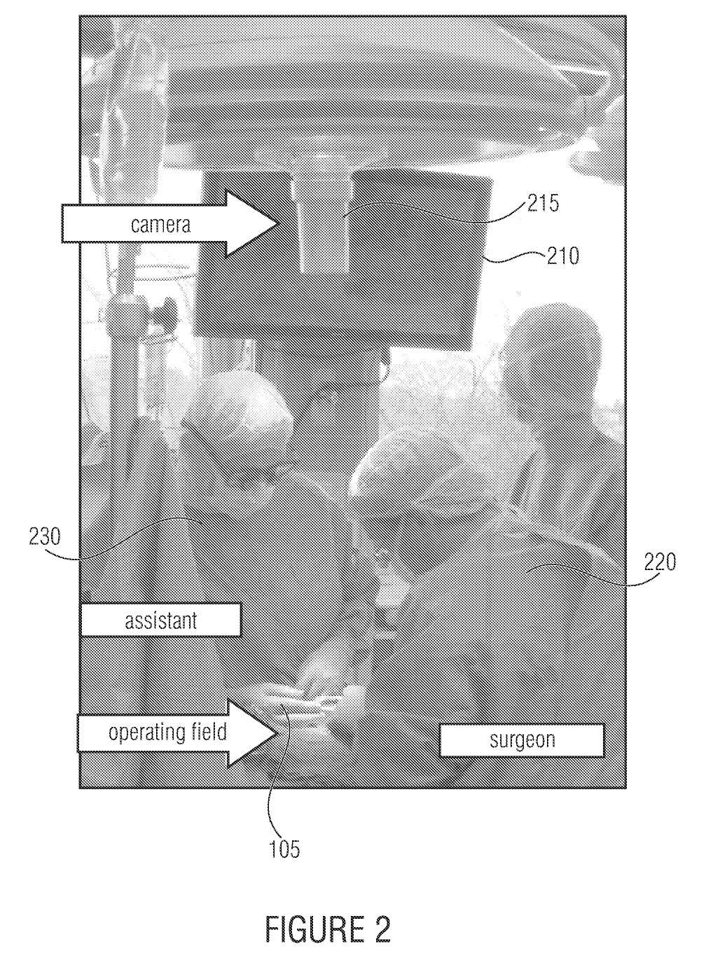

In accordance with some embodiments of the present invention, the means 110 for capturing and providing the first image 112 includes a camera or an endoscope and a display device so as to capture the operating field 105 in a time-sensitive manner by means of the camera or of the endoscope, and to present the live image 112 resulting therefrom on the display device. This situation is shown in FIG. 2. In accordance with embodiments, therefore, a monitor 210 is available which presents a live image of the intervention and/or of the operating field. In open surgery, a camera 215 may be employed above an operating table for this purpose, the monitor 210 advantageously being mounted close to a site of action of a surgeon 220. For minimally invasive interventions, a monitor display of the operating field 105 is typically present anyway.

In accordance with the present invention, the displayed live image 112 of the operating field 105 may be improved by means of modern visualization of corresponding preoperatively collected image data 114. Nowadays, preoperative images such as angiograms and cardiac computer tomography (cardiac CT) are available in a digital form and may be presented on a display device, such as on the monitor 210, by retrieving the preoperative image data 114 from a digital storage medium. In accordance with embodiments of the present invention, the means 120 for providing the second, preoperative image of the operating field thus includes a digital storage for storing the preoperative second image 114 and fetching it from the digital storage. In this context, the second, preoperative image 114 of the operating field 105 is, for example, an angiographic or cardiac computer tomographic image, obtained prior to the operation, i.e. prior to the live image 112, of the operating field 105, it being possible for said first and second images 112, 114 to have been taken from different perspectives.

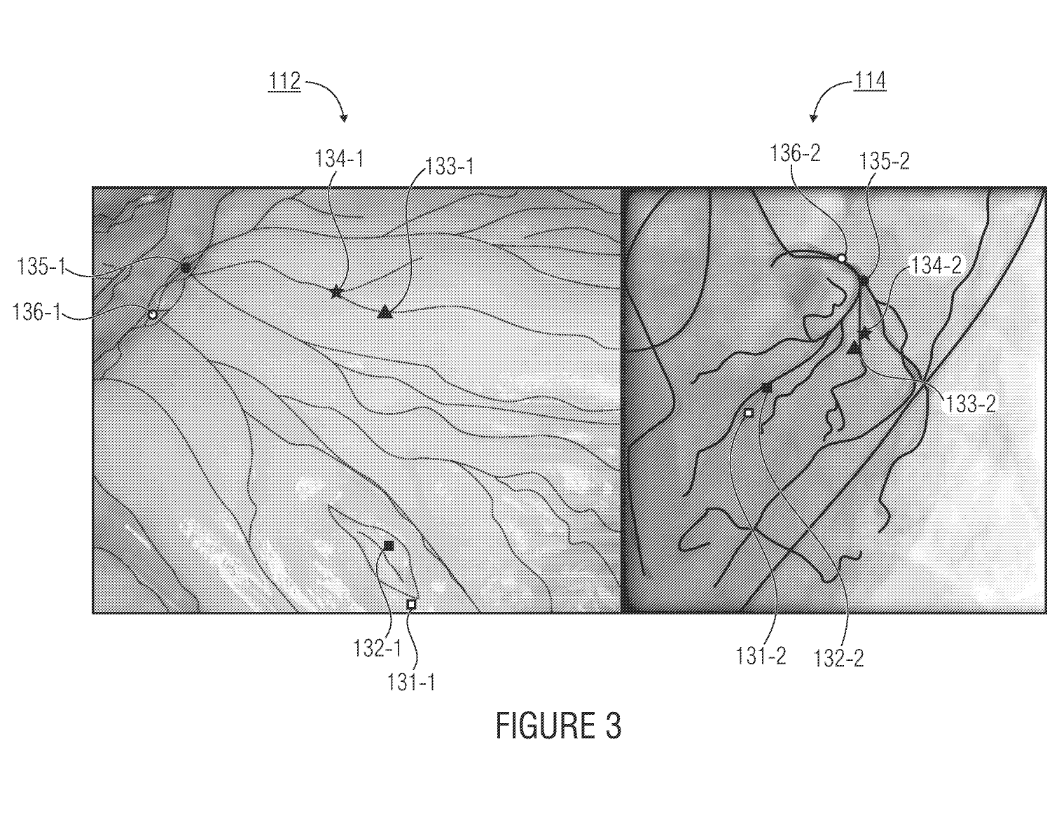

As a precondition for image registration with regard to the first and second images 112, 114, the surgeon 220 or an assistant 230 will identify and mark several visible and mutually different characteristic points 131-1, 132-1, . . . in the intraoperative live image 112 of the operating field 105, which may be the surface of the heart, for example. Similarly, several matching or corresponding points 131-2, 132-2, . . . in the preoperative image 114 are identified and marked. The characteristic points 131-1, 132-1, . . . and the points 131-2, 132-2, . . . corresponding thereto signify, in both images, mutually corresponding positions or areas of the operating field 105. This connection is shown in FIG. 3. On the left-hand side, FIG. 3 shows an intraoperative live image 112 of a heart, the cardiac wall of which is coated with a layer of fat, so that coronary vessels are not visible. The thin, dashed lines that have been drawn in merely signify contour lines of the cardiac wall. On the right-hand side in FIG. 3, an angiogram 114 of the heart is shown wherein coronary vessels (fat lines) are clearly visible.

Using the means 130, characteristic points 131-1 to 136-1 in the intraoperative live image 112 are defined which signify specific positions of the heart, i.e. of the operating field 105. To this end, the means 130 may include an electronic input device, such as a keyboard, a trackball, a computer mouse, a light pen or a touch-sensitive display. Corresponding thereto, points and/or landmarks 131-2 to 136-2, which correspond to the characteristic points or landmarks 131-1 to 136-1 defined in the first image 112 and which correspond to the same positions of the heart as do the points 131-1 to 136-1, are defined in the angiogram 114. This definition of characteristic points 131-1 to 136-1 in the live image 112 and of points 131-2 to 136-2, corresponding thereto, in the preoperative image 114 should advantageously be performed in an interactive manner by an experienced surgeon or assistant in that he/she marks and logically combines corresponding image positions of the characteristic points and of the corresponding points. Alternatively, in accordance with some embodiments, the characteristic points 131-1 to 136-1 in the live image 112 and the points 131-2 to 136-2, corresponding thereto, in the preoperative image 114 may also be defined in a fully automated manner in that, for example, the corresponding image positions of the characteristic points and of the corresponding points are automatically, i.e. without any human intervention, identified, marked and logically combined by means of, e.g., pattern and/or position recognition processes that are highly efficient and adapted to the image data. The defined characteristic points 131-1 to 136-1 and points 131-2 to 136-2 corresponding thereto signify corresponding locations, or positions, in the operating field 105, and thus form a basis for a transformation between both views or images 112, 114. Since the images 112, 114 to be registered typically were captured from different positions, at different points in time, and/or using different sensors, mutual mapping may be adapted accordingly.

Image registration is understood to mean a process of matching two or more images of the same scene or at least of similar scenes in the best possible manner. In accordance with the present invention, image registration is used for mapping an image of a modality (e.g. angiography) to an image of a second modality (live image and/or video) and, in accordance therewith, transform at least one of the two images 112, 114 so as to match the two images. “Modality” as a generic term designates various groups of devices which in medicine are used for imaging. These modalities are clearly assigned in DICOM (digital imaging and communications in medicine) systems and are, e.g., magnetic resonance tomography (MR), computer tomography (CT), ultrasound (US), “classic” X-ray examination (CR), and nuclear medicine (NM). For registering images originating from different modalities, wherein image intensity information is difficult or impossible to utilize, landmark-based image registration may be employed, for example. In accordance with embodiments, an interactively marked set of mutually corresponding landmarks 131-1 to 136-1 and 131-2 to 136-2 is used, accordingly, for defining a transformation which maps, e.g., the preoperative second image 114 to the intraoperative live video image 112, for example, or vice versa. Depending on the level of accuracy desired, affine mappings and/or transformations, or, alternatively, rigid transformations which are limited to rotation and translation, may be used. An affine transformation is a mapping which maintains, between two vector spaces, collinearities and distance ratios of parallel routes; maintenance of collinearity means that images of points that are located on a straight line, i.e. are collinear, will again be located on a straight line Likewise, images of parallel straight lines will be parallel. It is known that affine transformations lead to better matches between two images than do rigid transformations. However, rigid transformations may be performed faster and while using fewer characteristic and corresponding points 131-1, . . . and 131-2, . . . . Accordingly, the means 140 for transforming is adapted, in accordance with some embodiments, to map the second image 114 of the operating field 105 from a second perspective to the first image 112 of the operating field in the first perspective of the latter, or vice versa, by means of affine image transformation. In accordance with other embodiments, the means 140 for transforming is configured to map the second image 114 to the first image 112 on the basis of the characteristic points 131-1, 132-1, . . . and points 131-2, 132-2, . . . corresponding thereto, or vice versa, by means of rigid image transformation.

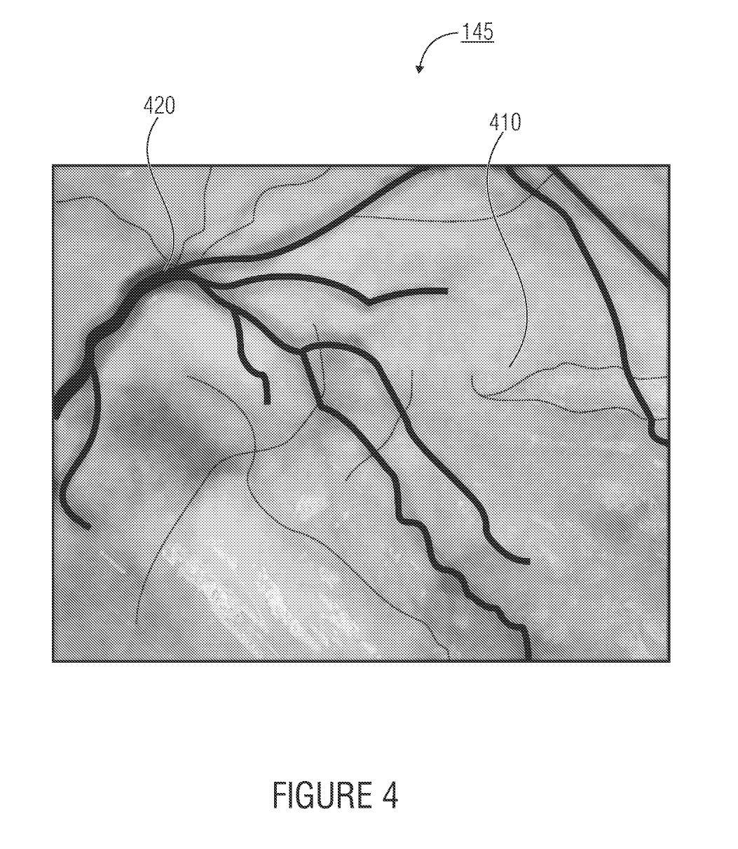

Following the transformation and mutual mapping of the images 112, 114, the transformed, or adapted, preoperative image 114 may be projected, in accordance with one embodiment, onto the intraoperative live image 112, or directly onto the open operating field 105 so as to obtain the combined view 145. For direct projection onto the situs, for example, a corresponding projector may be provided above the operating field 105. Also, specific “virtual-reality” glasses for the surgeon 220 are feasible wherein the two images are displayed in a superimposed manner. A superimposed display of the two images on the monitor 210 is also possible, of course. To ensure recognizability of an image 145 superimposed in this manner, the concept of an alpha channel may be employed, in accordance with embodiments. The alpha channel or cc channel is an additional channel which stores a transparency of the individual pixels (image points), in addition to the color information, in raster graphics. Representation of an image with an alpha channel against a background is referred to as alpha blending, which enables partial transparency and some kind of changed reality view, as is represented in FIG. 4.

FIG. 4 shows a superimposed, or combined, view, and/or a superimposed and/or combined image 145 of the live image 112 represented in FIG. 3 and of the perspectively transformed preoperative image 114. This means, the transformed second image 114 is superimposed, in accordance with FIG. 4, on the first image 112 in a manner that is correct in terms of perspective, so that a physician and/or surgeon 220 may recognize, e.g., coronary vessels 420 extending beneath a fatty tissue 410, whereby more successful operations are enabled.

Typically, a scenario represented in the live video image 112 will never be absolutely constant. For example, the pulse, camera movements and the surgical interventions themselves will permanently change a view of, or the image of, the operating field 105. This is why the characteristic points, and the points corresponding thereto, 131-1 to 136-1 and 131-2 to 136-2, respectively, all of which have been interactively selected by the surgeon, may be invalid after a short period of time (e.g. within seconds). Continuous re-selection of characteristic points and points corresponding thereto would not be an efficient approach. Rather, the mutual mapping of the two images 112, 114 should be adjusted to the respective image scene and be stabilized against movements for a sufficient period of time.

In accordance with one embodiment of the present invention, the characteristic points 131-1, 132-1, . . . defined in the first image 112 are tracked over time from frame to frame of a live video of the operating field 105, which means that they will be automatically identified in successive frames. That is, in accordance with an embodiment of the present invention, the means 110 for providing the first image 112 is configured to provide several images of the operating field 105 in a temporally successive manner, a tracking means being provided for tracking the positions of the defined characteristic points in the temporally successive frames, the means for transforming being configured to perform, on the basis thereof, a transformation for each of the several frames.

A robust and fast approach to tracking the image points in successive frames is so-called template matching, wherein similarities of an image region around a landmark and/or a defined characteristic point 131-1, 132-1, . . . are exploited. Template matching is understood to mean a comparison of a prototype of a pattern, which prototype is present in the form of a window and/or of a raster, with a raster image to be examined. For each position in the raster image, a correlation between the prototype and the corresponding image area is determined. Allocation or rejection of the pattern will depend on the correlation, i.e. on the quality of the comparison. In principle, a window and/or template is selected in a first frame of the live image sequence. Corresponding positions in successive frames are found on the basis of a similarity assumption. To this end, the window and/or template is partly shifted over a frame to be examined, a degree of matching being calculated. To shorten a computing time, an image section to be examined may be limited. When assuming that an offset of a characteristic point 131-1, 132-1, . . . between two successive frames is not too large, one needs to take into account only a limited region around the original position of the characteristic image point 131-1, 132-1, . . . . In accordance with the approach proposed in Frischholz, R., “Beiträge zur automatischen dreidimensionalen Bewegungsanalyse”, Shaker Verlag, Aachen, 1998, and Frischholz, R. W., Spinnler, K. P., ,, A Class Algorithm for Real-Time Subpixel Registration, In Proceedings of Euroopto Conference, Munich, 1993, pages 50-56, a window and/or template belonging to a scenario represented may be temporally adapted, whereby small, slow changes in the appearance of the landmark window are allowed.

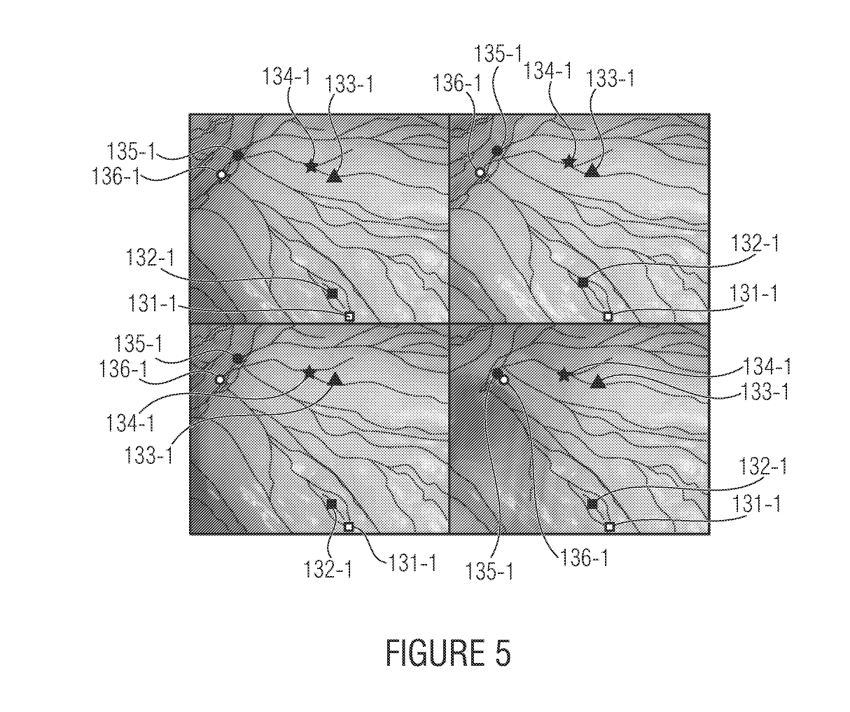

The landmarks 131-1 to 136-1 may be tracked during their movements as long as a change between successive frames is not too relevant or the view of the operating field 105 is not hidden (see FIG. 5). The partial image at the top left in FIG. 5 shows newly identified characteristic points 131-1 to 136-1 in a first frame of a live image and/or live video of an operating field 105. The positions of the characteristic points 131-1 to 136-1 are tracked, in successive frames, by a tracking algorithm (see the partial image at the top right and the partial image at the bottom left) until a view of the operating field 105 is restricted by the surgical intervention itself (see partial image at the bottom right). The tracked characteristic points 131-1 to 136-1 are used for adapting the mapping of the preoperative image 114 to the respectively current operating scene in accordance with a current frame. This enables continuous superposition of preoperative images 114 onto a live image 112 for sufficiently long periods of time. For non-trackable changes between successive frames, a matching measure is below a threshold value, so that tracking and mutual adaptation of the first and second images 112, 114 will stop. In this case, the characteristic image points 131-1, 132-1, . . . in the live image 112 and corresponding image points 131-2, 132-2, . . . in the preoperative image 114 will be redefined, so that superposition of the images following transformation may again be represented by means of a combined image 145.

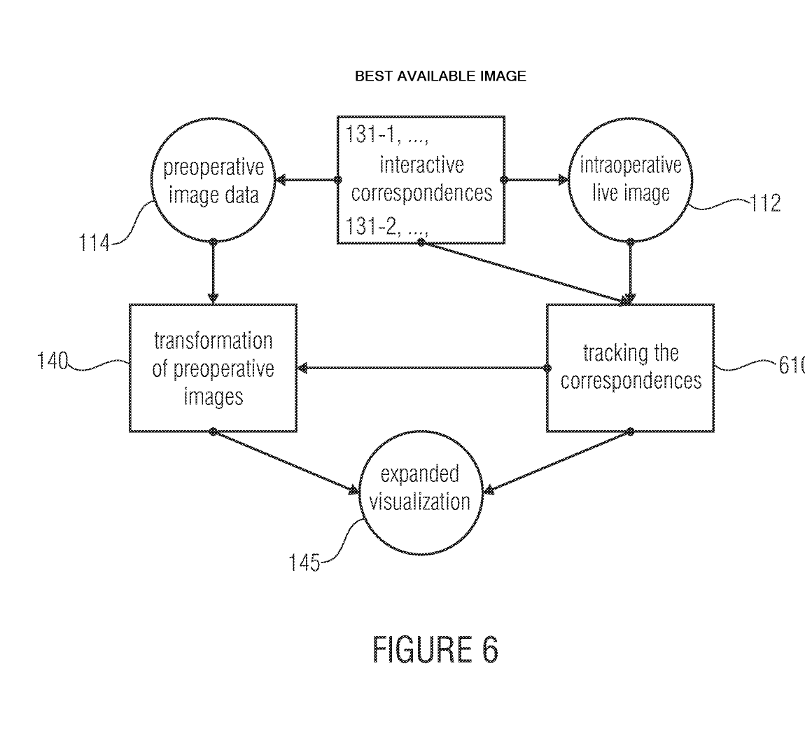

In terms of summary, FIG. 6 shows an overview of the inventive concept.

A current view of the operating field 105 is recorded by means of a camera 215, for example, so that an intraoperative live image 112 results. With open interventions, the camera 215 may be mounted, e.g., above an operating table, e.g. in an operating lighting unit. In the event of minimally invasive interventions, an optical channel of an endoscope enables producing the live image 112. The current live image 112 may be made available to a surgeon 220 on a monitor 210 directly accessible to him/her. Additionally, he/she may load preoperatively obtained image data and also have them displayed by means of the monitor 210. By interactively placing characteristic points 131-1 to 136-1, the surgeon 220 may mark landmarks of interest in the current view 112 of the operating field 105. He/she may define, in the preoperative image data 114, points 131-2, 132-2, . . . which correspond with said landmarks 131-1, 132-1, . . . . By means of said correspondences between the points 131-1, 132-1, . . . and 131-2, 132-2, . . . , the preoperative image data 114 may be transformed (140) in a sufficiently suitable manner so that, following transformation and superposition, those regions of the images which are of interest and which correlate in each case will lie one above the other. By means of said superimposed visualization (145), the surgeon 220 may be provided with an improved and/or expanded view of the projection field, or operating field 105. This may be effected either by superposing the image data on the monitor 210 or directly by projecting the transformed preoperative image data onto the situs. In this context, the transformed preoperative image is projected directly onto the situs by means of a projector.

Since during the operation the view of the situs, or the situs itself, does not remain constant, and since said situs is often moved physiologically, the corresponding landmarks are tracked by using a suitable tracking process (610). In this context, methods of movement tracking, in particular of point tracking, are employed. In this manner, the movements and, thus, also the landmarks may be tracked over time. The transformation and the superposition resulting therefrom are adapted, for each new live frame 112, in accordance with the new landmark positions.

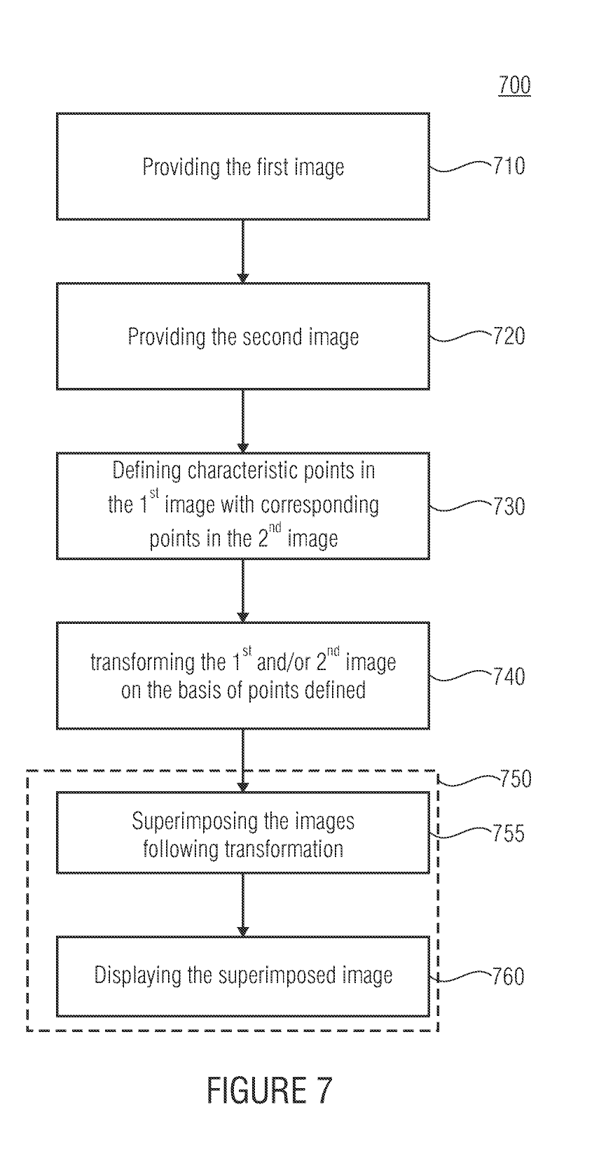

A method of superimposing an intraoperative live image 112 of an operating field 105 with a preoperative image 114 of the operating field will now be described by means of FIG. 7.

In a first step 710, the first image 112, i.e. the intraoperative live image, is provided. In addition, in a second step 720, the second image 114, i.e. the preoperative image of the operating field, is provided. In a subsequent step 730, characteristic points 131-1, 132-1, . . . in the first image 112 and points 131-2, 132-2, . . . in the second image 114, which correspond thereto, are defined such that the characteristic points and the points corresponding thereto in the first and second images mark mutually corresponding positions of the operating field 105. In a next step 740, the first and/or second image(s) is transformed, so that the characteristic points 131-1, 132-1, . . . of the first image 112 and the points 131-2, 132-2, . . . of the second image which correspond thereto 114 essentially come to lie one above the other. Transformation 740 is followed by a step 750 of superimposing the second image with the first image or with the operating field so as to obtain the superimposed view 145 of the operating field 105. In accordance with an advantageous embodiment of the present invention, the second image 114 may be transformed, to this end, whereupon the first image 112 and the transformed second image 114 may be superimposed so as to obtain a combined, or superimposed, image 145, which is displayed, in a step 760, e.g. via a monitor or projector. Alternatively, it would also be possible to transform the live image 112, which will generally involve more effort, however.

Even though in the present disclosure some aspects have been described in connection with a device for superimposing an intraoperative live image with a preoperative image, it shall be understood that said aspects also represent a description of the corresponding method of superimposing an intraoperative live image with a preoperative image, so that a block or a component of a device also may be understood as a corresponding method step or as a feature of a method step. By analogy therewith, aspects that have been described in connection with or as a method step shall also represent a description of a corresponding block or detail or feature of a corresponding device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. Currently, the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A device for superimposing an intraoperative first live image of an operating field with a preoperative second image of the operating field, comprising:
a capturer/provider for capturing and providing the first image;
a provider for providing the second image;
a definer for defining characteristic points in the first image and for defining points, which correspond to the characteristic points, in the second image, so that the characteristic points and the points corresponding thereto in the first and second images will mark mutually corresponding positions of the operating field, wherein the definer for defining the characteristic points and the points corresponding thereto comprises an electronic input device so as to mark the characteristic points in the first image and the corresponding points in the second image, respectively;
a transformer for transforming the first and/or second image(s), so that the characteristic points of the first image and the points, which correspond thereto, of the second image will come to lie one above the other; and
a superimposer for superimposing, following transformation, the second image with the first image or with the operating field so as to acquire a superimposed view of the operating field,
wherein the provider for providing the first image is configured to provide several frames of the operating field in a temporally successive manner, a tracker being provided for tracking the positions of the defined characteristic points in the temporally successive images, and the transformer being configured to perform, on the basis thereof, a transformation for each of the several frames.

2. The device as claimed in claim 1, wherein the provider for providing the first image comprises a camera or an endoscope and a display device so as to detect the operating field from a first perspective in a time-sensitive manner by means of the camera or of the endoscope and to represent the first image resulting therefrom on the display device.

3. The device as claimed in claim 1, wherein the provider for providing the second image comprises a digital storage so as to store the second image and to fetch it from the digital storage.

4. The device as claimed in claim 3, wherein the second image is an angiogram or cardiac computer tomogram of the operating field which has been acquired prior to the first image.

5. The device as claimed in claim 1, wherein the transformer is adapted to map the second image of the operating field from a second perspective to the first image of the operating field in a first perspective, or vice versa, by means of an affine or rigid image transformation.

6. The device as claimed in claim 5, wherein the superimposer is configured to directly project the transformed second image onto the operating field so as to acquire the superimposed view.

7. The device as claimed in claim 1, wherein the superimposer is configured to superimpose, following transformation, the second image with the first image or with the operating field by means of an alpha blending technique so as to acquire a combined image in accordance with the superimposed view.

8. The device as claimed in claim 7, configured to display the combined image on a display device.

9. The device as claimed in claim 1, wherein the tracker is configured to track the defined characteristic points by means of a template matching process.

10. The device as claimed in claim 1, wherein the operating field is a surgical operating field.

11. The device as claimed in claim 1, wherein the device is configured for interactive registration of preoperative image data and intraoperative live images.

12. A method of superimposing an intraoperative first live image of an operating field with a preoperative second image of the operating field, comprising:
capturing and providing the first image;
providing the second image;
defining characteristic points in the first image and for defining points, which correspond to the characteristic points, in the second image, so that the characteristic points and the points corresponding thereto in the first and second images will mark mutually corresponding positions of the operating field, wherein said defining of the characteristic points and of the points corresponding thereto comprises an electronic input device so as to mark the characteristic points in the first image and the corresponding points in the second image, respectively;
transforming the first and/or second image(s), so that the characteristic points of the first image and the points, which correspond thereto, of the second image will come to lie one above the other; and
following transformation, superimposing the second image with the first image or with the operating field so as to acquire a superimposed view of the operating field,
wherein said providing of the first image comprises providing several frames of the operating field in a temporally successive manner, a tracker being provided for tracking the positions of the defined characteristic points in the temporally successive images, and the transformer being configured to perform, on the basis thereof, a transformation for each of the several frames.

13. A non-transitory computer readable medium including a computer program for performing, when the computer program runs on a computer or microcontroller, a method of superimposing an intraoperative first live image of an operating field with a preoperative second image of the operating field, said method comprising:
capturing and providing the first image;
providing the second image;
defining characteristic points in the first image and for defining points, which correspond to the characteristic points, in the second image, so that the characteristic points and the points corresponding thereto in the first and second images will mark mutually corresponding positions of the operating field, wherein said defining of the characteristic points and of the points corresponding thereto comprises an electronic input device so as to mark the characteristic points in the first image and the corresponding points in the second image, respectively;
transforming the first and/or second image(s), so that the characteristic points of the first image and the points, which correspond thereto, of the second image will come to lie one above the other; and
following transformation, superimposing the second image with the first image or with the operating field so as to acquire a superimposed view of the operating field,
wherein said providing of the first image comprises providing several frames of the operating field in a temporally successive manner, a tracker being provided for tracking the positions of the defined characteristic points in the temporally successive images, and the transformer being configured to perform, on the basis thereof, a transformation for each of the several frames.
